(19) United States
(12) Patent Application Publication
(10) Pub. No.: US 2003/0005261 A1
(43) Pub. Date: Jan. 2, 2003

(54) Method and apparatus for attaching accelerator hardware containing internal state to a processing core

(76) Inventor: Gad Sheaffer, Haifa (IL)

Correspondence Address: KENYON & KENYON (SAN JOSE), 333 WEST SAN CARLOS ST., SUITE 600, SAN JOSE, CA, 95110, US

(21) Appl. No.: 09/896,423

(22) Filed: Jun. 29, 2001

(51) Int. Cl. G06F 15/00

(52) U.S. Cl. 712/35

(57) ABSTRACT

A digital signal processor system and method for improving processing speed by providing a memory file and a register file connected to an accelerator which is connected to a write-back logic bus. One or more execution units can be connected between the memory and register files and the accelerator and/or between the accelerator and the bus. The accelerator is provided with internal state. The internal state is configured to enable increasing the ratio of computation operations to the memory bandwidth available from a digital signal processor.

### FIELD OF THE INVENTION

The present invention relates to the acceleration of processing. More particularly, the present invention relates to attaching accelerator hardware containing internal state to a processing core.

### BACKGROUND INFORMATION

Modern microprocessors implement a variety of techniques to increase the performance of executing instructions including superscalar and pipelining execution. Superscalar microprocessors are capable of processing multiple instructions within a common clock cycle. Pipelined microprocessors divide the processing of an operation into separate pipestages and overlap the pipestage processing of subsequent instructions in an attempt to achieve single pipestage throughput performance.

In any particular processing system, it can happen that a code will consume too many cycles on the execution units within the processing core and thus is not efficient. Accelerator blocks are execution units modified to perform certain specialized tasks, for example, interleaving, more efficiently. Thus, the accelerator blocks, situated as hardware used in a processing system, optimize execution of those specialized tasks and the regular execution units execute the other tasks. For example, if there are seventeen tasks to be performed concurrently and one task takes 20% of the time, the overall processing can be reduced by using accelerator blocks focused particularly to that one task. The remaining 16 tasks can then be processed more efficiently and in fewer cycles by the regular execution units because the 17^{th} task requiring 20% of the processing time has been effectively removed from that path.

### BRIEF DESCRIPTION OF THE DRAWINGS

FIG. 1 depicts a block diagram of accelerator blocks in a general processing core according to an embodiment of the present invention.

FIG. 2 depicts a block diagram of an accelerator block having internal state according to another embodiment of the present invention.

FIG. 3 depicts a block diagram of an accelerator block in a general processing core according to another embodiment of the present invention.

FIG. 4 depicts a block diagram of an accelerator block according to another embodiment of the present invention.

FIG. 5 depicts a block diagram of accelerator blocks in a general processing core according to another embodiment of the present invention.

FIG. 6 depicts a block diagram of accelerator blocks in a general processing core according to yet another embodiment of the present invention

### DETAILED DESCRIPTION

In the detailed description, various systems, circuits and interfaces are described in block form and certain well-known elements, devices, process steps and the like are not described in detail to avoid any unnecessary obscurement of the present invention.

When accelerator blocks are operated in parallel with the execution units in a general processing core of a signal processor, the accelerator blocks can provide a more efficient path for the processing codes/signals. Accelerator hardware can be attached to the process core on the outside of the general processing core. In such a case, the general processing core sends blocks of data to the accelerator and the accelerator then transmits that processed data back to the general processing core. In the present invention, the accelerator blocks, or hardware, may be attached within the general processing core. Further, the accelerator blocks may be provided with internal state. The internal state allows the accelerator blocks to have available memory. Further, in the present invention, the accelerator blocks can be operated in parallel with the regular execution units. The accelerator blocks and the regular execution units are connected to the same inputs/outputs. Further, one or both of the accelerator blocks and the regular execution units can provide specialized operation for the off-load work.

Generally, the regular non-pipeline execution units operate on what enters in the current cycle and do not maintain any memory. The internal state of the accelerator block according to an embodiment of the present invention provides a capacity for storing data for the accelerator block. The execution units are fed data by the same buses, write back data to the same buses and are operated in the same manner as the accelerator blocks. A further embodiment of the present invention includes making additional memory available to the accelerator block.

Embodiments of the present invention further provide an accelerator block or a plurality of accelerator blocks which may or may not have internal state and can be inserted into already existing general processing cores of digital signal processors or attached to the outside. While the regular execution units do not have memory or internal state, the accelerator block of the present invention is provided with internal state and does have memory.

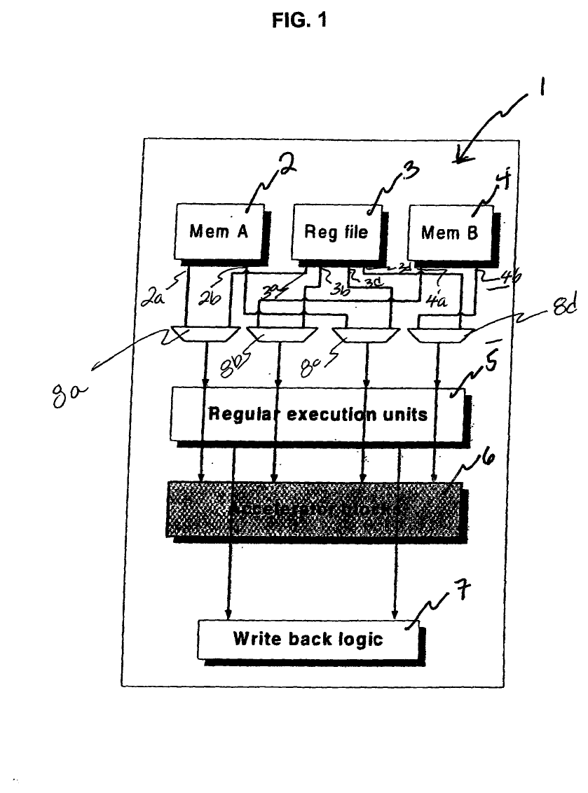

Referring to FIG. 1, a block diagram of accelerator blocks 6 in a general processing core 1 of a digital signal processor (DSP) according to an embodiment of the present invention is shown. In this embodiment of the present invention, the hardware accelerator blocks 6 can be attached between the memory file ports 2, 4 and/or register file ports 3 and the write-back bus 7 of either the digital signal processor 1 or any general-purpose processor. Multiplexer units 8a,b,c,d, or data selectors, are used for selecting the information from the memory and register file ports 2,3,4 and direct the information to the regular execution units 5 and/or the acceleration blocks 6. The accelerator blocks 6 can include, among other things, larger precision accumulators, temporary registers holding previous values of either outputs, inputs or intermediate results, registers arranged as FIFO structure, scratch pad memory arranged as either caches or directly addressable, accumulators containing higher precision versions of the computed results, special purpose registers containing status flags generated by the execution hardware, and registers arranged as shift registers. The regular execution units 5 can provide support for copying the contents of the accumulator into either registers or memory along with saturation and down-shifting for precision adjustment and packing.

The accelerator block 6 in FIG. 1 is attached to all the operand ports of the processor, and can therefore use the fall memory bandwidth of the processing core 1; bandwidth being the difference between the frequency limits of a band containing the useful frequency components of a signal. The accelerator block 6 can also be activated by a single instruction in one of the issue slots and occupy part or all the memory bandwidth, while another instruction in a second issue slot can use the core's other resources in parallel.

In FIG. 1, the core is balanced with respect to the number of execution units so that there is no overabundance of execution units or of a number of operands. In FIG. 1, the number of operands 2a,b, 3a,b,c,d, 4a,b from the memory and register units can be used by the regular execution units 5, without any operands remaining idle or unused. If an additional accelerator block having no internal state was attached in parallel to the regular execution units, then the accelerator block would be idle or unused because there are no additional operands to be used. Thus, if the accelerator blocks are to be run in parallel, they need to be provided with bandwidth.

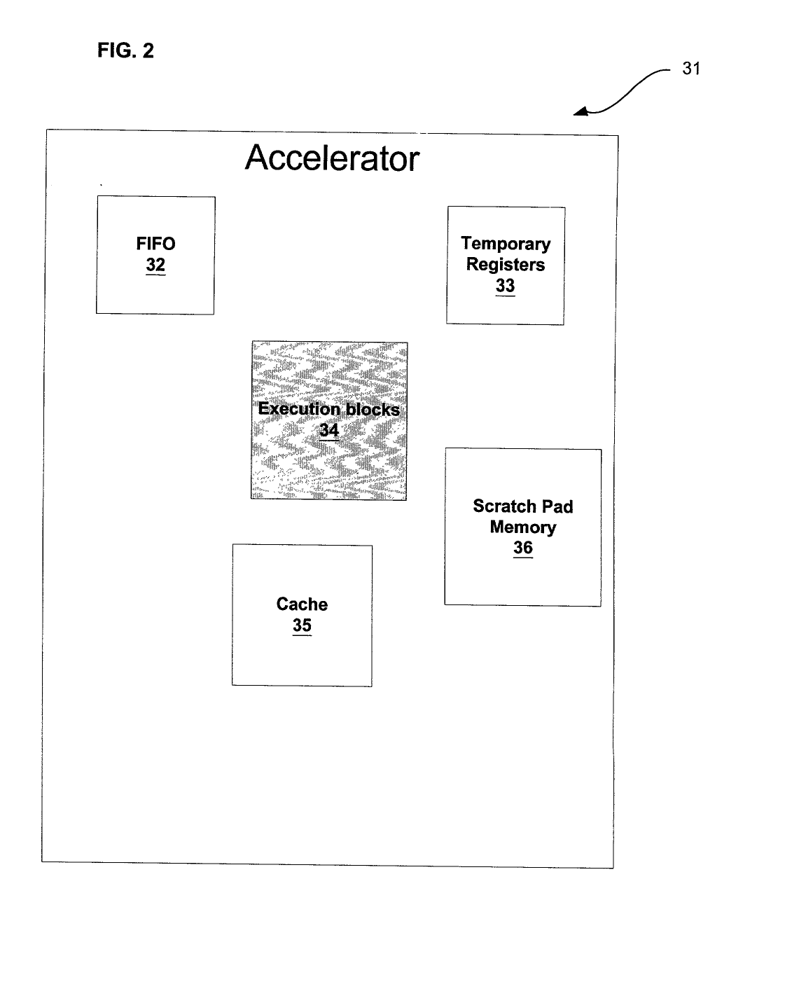

Referring to FIG. 2, an exemplary accelerator block 31 having internal state according to an embodiment of the present invention is shown. The accelerator block 31 may contain a FIFO register 32, other temporary registers 33, execution blocks 34, a cache 35, and a scratch pad memory 36.

An exemplary embodiment of the present invention includes a processor having an accelerator which is provided with internal state. For example, in FIG. 2, an exemplary accelerator having a FIFO (First In First Out) register 32 according to the present invention is shown. In this embodiment, the FIFO register 32 samples operands entering the execution blocks 34 so that there are copies stored in the memory of the accelerator block 31 of the input operand from the execution unit blocks 34 from the previous, e.g., three cycles. Thus, a regular execution unit operating outside the accelerator block 31 can operate on the input operand during a current cycle while the accelerator block works on input operand from a previous cycle. For example, a first vector set of operands is A₁, B₁ and a second vector set of operands is A₂, B₂. When the first set of operands enter the regular execution units, the regular execution units operate on that current vector set, that is, the first vector set of operands A₁, B₁. Likewise, when the second set of operands enter the regular execution units, the regular execution units operate on that current set, that is, the second vector set of operands A₂, B₂. However, the accelerator block 31 can store operand A₁ from the first set and then operate on operand A₁ with operand B₂ while the regular execution units are operating, e.g., multiplying, on operands A₂ and B₂.

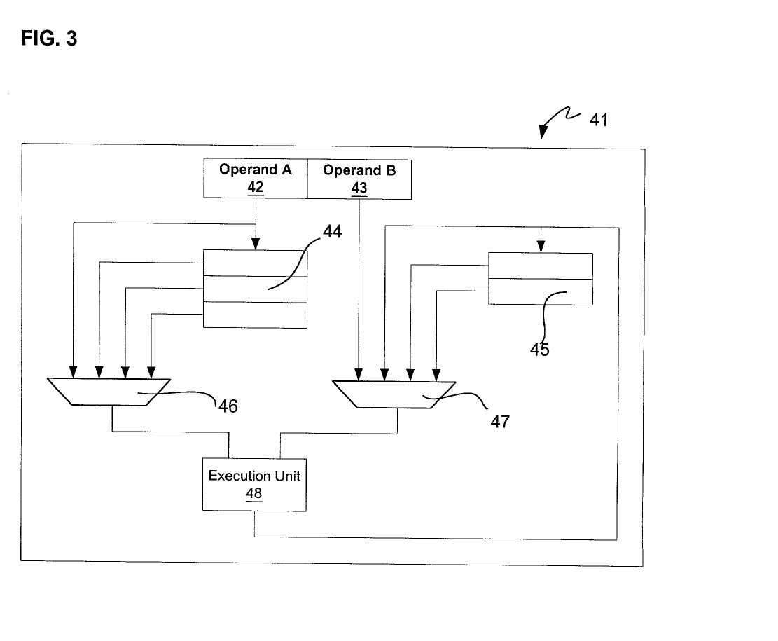

Referring to FIG. 3, an exemplary system and method of an accelerator block 41 having internal state according to an embodiment of the present invention is shown. Operand A 42 is sent to an execution unit 44 and to a multiplexer 46. Operand B 43 is sent to the multiplexer 47. A possibly delayed operand is sent to the same multiplexer from the execution unit 45. The outputs of both multiplexers 46, 47 are sent to an execution unit 48. The execution unit 48 forwards the result from a cycle to the execution unit 45. Further, execution unit 44 may store the input operand from Operand A 42 from a previous cycle and then forward it to the multiplexer 46 in a later cycle.

The multiplexers in the general processing core can select the source of data, e.g., register or memory, and forward that data to the regular execution units and the accelerator block(s).

In a further example of the present invention, when there are several intermediate variables, the accelerator block can be provided with additional memory to handle the variables. In this example, the memory inside the accelerator block also appears to serve as a scratchpad for the accelerator block. If the accelerator block did not have internal state, then one would not be able to use the execution unit in the accelerator block because of the data and the memory requirements.

According to an example of the present invention, an accelerator block can be plugged into the general processing core to handle n bits of data, where n is less than m. So, for the accelerator block, there is a mismatched m and n, so when kernals differ in m and n, it is useful to use the accelerator block having internal state and connected in the general processing core as described in the examples of the present embodiment. Kernal A requires more than n bits of data. If kernal A requires m data/cycle, where m>n. The accelerator block can use its internal state to fill in the difference between m and n. For example, if 64 bytes are needed at the input and output to do X at a Y rate, but the code gives only 32 bytes in and 32 bytes out, the remaining number of bytes needed can come from the internal state of the accelerator. The internal state of the accelerator can add some bytes from the previous cycles.

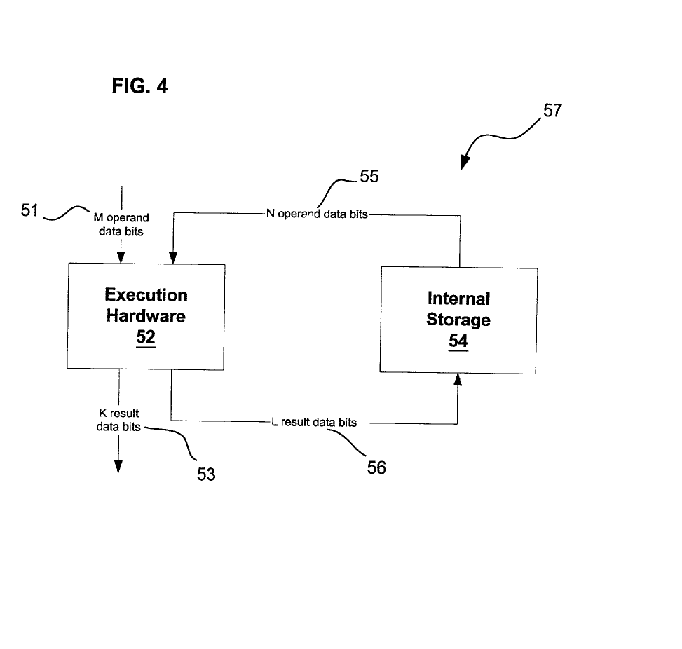

Referring to FIG. 4, an exemplary accelerator block 57 that can be plugged into the general processing core is shown. Input 51 of M operand data bits and input 55 of N operand data bits are inputted to the execution hardware 52. The output 23 of the execution hardware 52 may include any K result data bits. The output 56 of the execution hardware 52 may include any L result data bits. The output 56 of the L result data bits may be inputted into internal storage 54. The output 55 of the internal storage 54 is then fed to the execution hardware.

Specifically in the embodiments of the present invention, the accelerator blocks contain internal state. That internal state enables increasing the ratio of computation operations to memory bandwidth and enable adding more execution resources onto a given micro-architecture, without increasing the memory and register file available bandwidth.

Assuming that the ratio of computation to memory bandwidth in the micro-architecture to which the accelerator blocks 6 are attached (the host processing core) is already balanced, accelerator blocks which perform specialized operations designed to perform among other things can be added into any embodiments described herein of the present invention. If some operands and/or intermediate results are latched and stored inside the accelerator blocks 6, then a much larger number of computation units can be attached to an existing micro-architecture, within a given memory bandwidth.

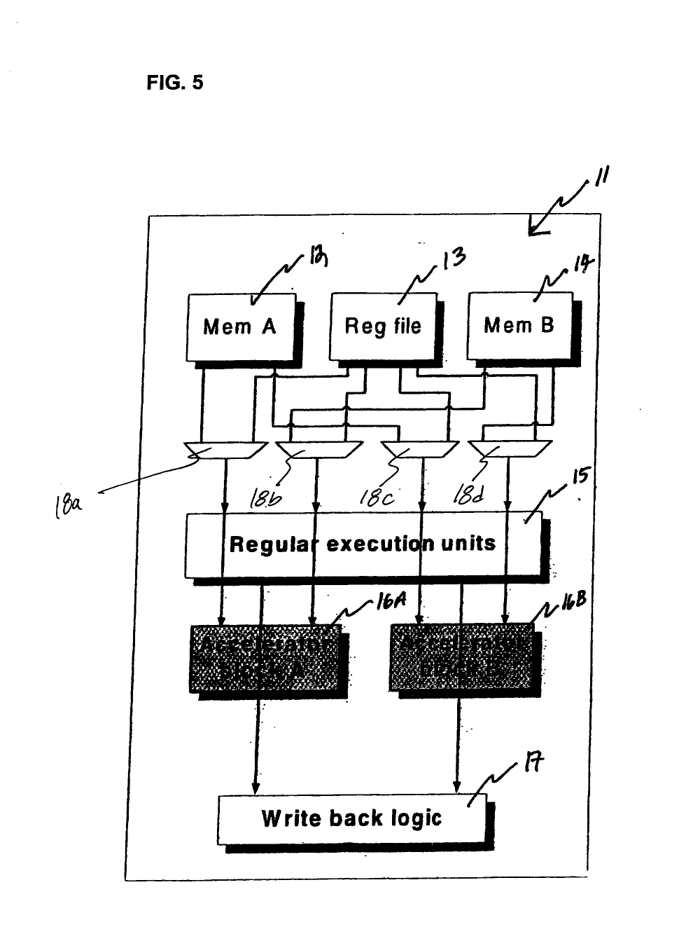

Referring to FIG. 5, a block diagram of accelerator blocks 16A, 16B in a general processing core of a digital signal processor system 11 according to an embodiment of the present invention is shown. In this embodiment, the memory and register files 12, 13, 14 are connected via multiplexers 18a,b,c,d to the regular execution units 15 and/or the accelerator blocks A and B 16A, 16B. In this embodiment of the present invention, the two accelerator blocks 16A, 16B, are attached, each to an execution pipeline of the execution units 15. These two execution units/pipelines can be either identical or different. In a general purpose superscalar architecture, if the two execution units/pipelines are different, such asymmetry can be accounted for using additional hardware or algorithms to recognize the difference and adjust accordingly for the different processing times and other differences of the pipelines employed. Having two distinct but identical accelerator blocks can provide another measure of flexibility, at a cost of a higher fetch bandwidth. The two accelerator blocks can each communicate with writeback logic/bus 17.

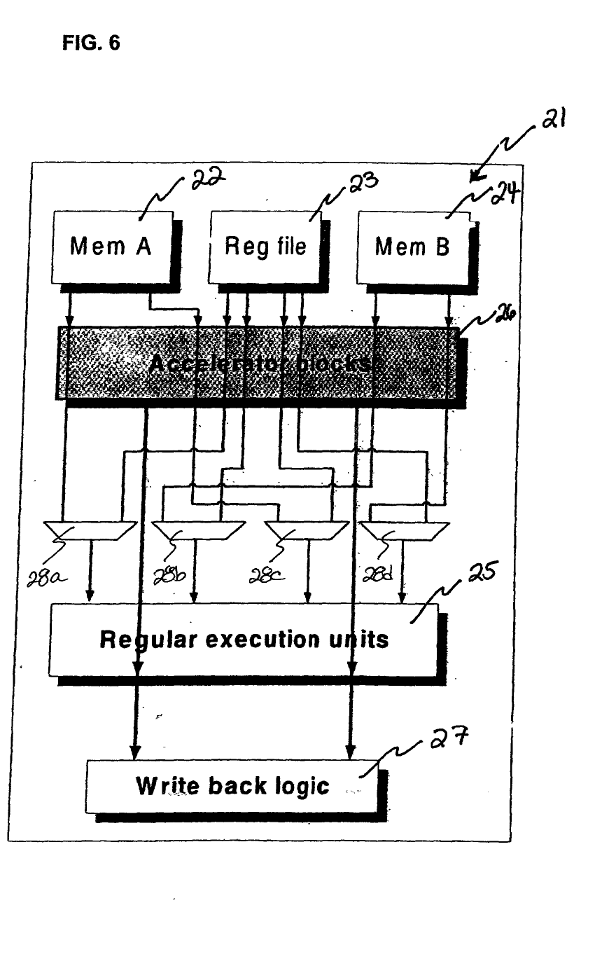

Referring to FIG. 6, a block diagram of accelerator blocks 26 in a general processing core 21 according to an embodiment of the present invention is shown. In this embodiment of the present invention, an accelerator block 26 is attached to both the memory 22, 24 and register file ports of the processing core, plying it with even greater bandwidth. The bandwidth can effectively be almost doubled in size. Each operand can be from the memory or the register. In this embodiment of the present invention, additional multipliers and/or multiplexers 28a,b,c,d can be used for shifting and sorting in embodiments of the present invention. In effect, the accelerators having internal state according to the present invention can be modified in their architecture to perform any number of operations, including multiplication, shifting and sorting.

In FIG. 6, there are eight input operands. The regular execution units 25 can take four of the eight input operands. The accelerator blocks 26 are controlled by the same instructions as the regular execution units 25. That is, a single instruction can control both the regular execution units and the accelerator blocks (having internal state), unlike in the past when a bus forwarded chunks of data outside of the general processing core to an accelerator block which then worked on the chunk of data separately and with special instructions.

Embodiments of the present invention also can include accelerator blocks which read external data sources in addition to previous options.

Embodiments of the present invention introduce methods to attach accelerator blocks to the existing buses in order to increase the efficiency of the executed operations.

Although several embodiments are specifically illustrated and described herein, it will be appreciated that modifications and variations of the present invention are covered by the above teachings and within the purview of the appended claims without departing from the spirit and intended scope of the present invention. For example, the present invention can be expanded, for example, to involve additional accelerator blocks having internal state attached to execution pipes 25 and/or memory and register file ports 22, 23, 24 of a processing core.

What is claimed is:

1. A digital signal processor system comprising:
at least one accelerator having internal state and being connected to a bus; and
at least one of a memory file and a register file, wherein the at least one of the memory file and the register file is connected to the at least one accelerator.

2. The system of claim 1, wherein the bus has write-back logic.

3. The system of claim 2, wherein the internal state of the accelerator is configured to add additional execution resources without increasing the memory bandwidth of the digital signal processor system.

4. The system of claim 1, wherein the internal state of the accelerator includes at least one of a precision accumulator, a temporary register to hold previous values, a FIFO structure register, a scratch pad memory configured as a cache, a scratch pad memory configured as directly addressable, a special purpose register to contain status flags generated, and a shift register.

5. The system of claim 1, wherein the internal state is configured to provide additional stored data bits from a previous cycle to a current cycle.

6. The system of claim 2, wherein the internal state of the accelerator is configured to enable increasing a ratio of computation operations to memory bandwidth of the digital signal processor system.

7. The system of claim 3, wherein the at least one accelerator contains at least one precision accumulator.

8. The system of claim 7, further comprising:
at least one execution unit connected between the at least one memory file and register file and the at least one accelerator.

9. The system of claim 7, further comprising:
at least one execution unit connected between the at least one accelerator and the bus.

10. The system of claim 8, wherein the at least one execution unit is configured to copy data from the at least one precision accumulator into an execution unit memory, the at least one execution unit being further configured to adjust and package the data copied from the at least one precision accumulator.

11. The system of claim 9, wherein the at least one execution unit is configured to copy data from the at least one precision accumulator into an execution unit memory, the at least one execution unit being further configured to adjust and package the data copied from the at least one precision accumulator.

12. The system of claim 4, wherein the at least one accelerator is attached to all operand ports of the digital signal processor system and is configured to use the full memory bandwidth of the digital signal processor system.

13. The system of claim 4, wherein the at least one accelerator has a first issue slot and a second issue slot and is configured to be activated by a first instruction in the first issue slot while a second instruction in the second issue slot executes in the digital signal processor system in parallel with the first instruction in the first issue slot.

14. A digital signal processor system comprising:
a first accelerator and a second accelerator; and
at least one of a memory file and a register file,
wherein the at least one of the memory file and the register file are connected to at least one of the first accelerator and the second accelerator via at least one multiplexer,
wherein the at least one of the first and second accelerators have an internal state and are connected to a bus.

15. The system of claim 14, wherein the internal state includes at least one of a precision accumulator, a temporary register to hold previous values, a FIFO structure register, a scratch pad memory configured as a cache, a scratch pad memory configured as directly addressable, a special purpose register to contain status flags generated, and a shift register.

16. The system of claim 14, further comprising:
at least one execution unit,
wherein the first and second accelerators are attached to a first and second execution pipeline, respectively, of the at least one execution unit, the first and second execution pipelines being configured as one of identical pipelines and non-identical pipelines, the execution unit being connected to a write-back logic bus.

17. The system of claim 16, wherein the first and second execution pipelines are non-identical pipelines, and
further comprising hardware to recognize if the first and second execution pipelines process data at different speeds.

18. The system of claim 17, wherein the hardware recognizes that the first and second execution pipelines process data at different speeds and then at least one of i) an alert indication is activated and ii) the first and second execution pipelines are modified so that the data is processed at similar speeds.

19. A method for attaching accelerator hardware to a processing core of a digital signal processor, comprising:
providing at least one of a memory file and a register file;
connecting an accelerator to the at least one of the memory file and the register file;
providing the accelerator with an internal state, the internal state being configured to enable increasing a ratio of computation operations to the memory bandwidth of the processor; and
connecting the accelerator to a bus.

20. The method of claim 19, further comprising:
connecting an execution unit between the accelerator and the at least one of the memory file and the register file; and
wherein the bus is configured to contain write-back logic.

21. The method of claim 19, further comprising:
connecting an execution unit between the accelerator and the bus; and
wherein the bus is configured to contain write-back logic.

22. The method of claim 19, wherein the internal state of the accelerator includes at least one of a precision accumulator, a temporary register to hold previous values, a FIFO structure register, a scratch pad memory configured as a cache, a scratch pad memory configured as directly addressable, a special purpose register to contain status flags generated, and a shift register.
